(19) United States
(12) Patent Application Publication
(10) Pub. No.: US 2011/0237198 A1
(43) Pub. Date: Sep. 29, 2011

(54) Method and System for Super-Resolution Blind Channel Modeling

(76) Inventors: Man-On Pun, Cambridge, MA (US); Philip V. Orlik, Cambridge, MA (US)

(21) Appl. No.: 12/731,962

(22) Filed: Mar. 25, 2010

(51) Int. Cl. H04B 17/00

(52) U.S. Cl. 455/67.11

(57) ABSTRACT

Propagation channels are reconstructed from measurements in disjoint subbands of a wideband channel of interest. By using high-resolution estimation of multipath parameters, and suitable soft combining of the results, a channel estimate and subseqeuntly channel models can be extracted that accurately interpolate between the measured subbands.

### FIELD OF THE INVENTION

This invention relates generally to channel measurement, channel estimation and channel modeling for wireless channels.

### BACKGROUND OF THE INVENTION

Accurate characterization of wireless propagation channels plays a critical role in designing high-performance wireless systems. As demonstrated in Shannon's seminal work, the fundamental performance limits of wireless transmission are dictated by the wireless channel characteristics. Hence, an in-depth understanding of the underlying channel can facilitate system architects to design, optimize and subsequently analyze practical wireless systems.

For the purpose of system development, channel models based on measurements are essential. Conventionally, channel measurements are performed by sending and measuring sounding signals over the entire frequency band of interest. However, there are often challenging situations in which sounding signals can be transmitted only over some parts of the frequency band of interest, rather than the entire band. Such challenges arise in a number of practical situations including regulatory restrictions, measurements with interference and re-use of narrowband measurements.

First of all, as some legacy wireless services, such as analog TV broadcasting are eliminated or relocated from particular frequency bands, the freed-up bands may be re-grouped to provide various broadband services. Thus, channel models for these wideband channels are required to develop future applications even before the legacy services are terminated. However, measurements of the channel characteristics can only be performed in the “whitespace” between the existing channels while the legacy services are still operating.

Second, for many measurements, it is impossible to guarantee absence of interference over the entire desired bandwidth, which is particularly true for ISM (Industrial, Scientific, and Medical) bands due to their license-free operation. Conventionally, all measurements contaminated by interference have to be discarded, despite the fact that the bandwidth of the interference is often smaller than the measurement bandwidth. Given the high cost incurred during channel measurements, it is thus highly desirable if channel models can be directly derived from the interference-free measurements over some parts of the desired frequency band.

Third, each generation of wireless data system occupies more bandwidth than the previous one, and needs therefore more broadband channel models. While such broadband channel models can be derived through new measurement campaigns, the enormous efforts incurred make it worthwhile to investigate whether or not existing narrowband measurements in adjacent frequency bands can be re-used.

The following notational convention is used in this invention. Vectors and matrices are denoted by boldface letters. (•)†, (•)^{T} and (•)_{H} stand for the Moore-Penrose pseudoinverse, transpose operation and Hermitian transposition, respectively. |•| denotes the amplitude of the enclosed complex-valued quantity while └x┘ is the maximum integer less than x. Furthermore, [A]_{i,j} denotes the i^{th} row and j^{th} column entry of the matrix A whereas A(q,:) the q column of matrix A. Finally, I_{N} is the N×N identity matrix while F_{N} is the N-point discrete Fourier transform (DFT) matrix with entries

$${[ F ]}_{n , k} = \frac{1}{\sqrt{N}} exp ( \frac{- j 2 π nk}{N} ) for 0 \leq n , k \leq N - 1.$$

### SUMMARY OF THE INVENTION

The embodiments of the invention provide a method for estimating a frequency response of a wideband channel, and subsequently extracting a channel model when only measurements in parts of the wideband channel are available, specifically in disjoint narrow frequency subbands.

Conventional channel modeling techniques cannot model parts of the band where no sounding signals are available; or, if the techniques use conventional interpolation, suffer from poor performance.

To circumvent this obstacle, the embodiments provide a three-step super-resolution blind method. First, path delays are estimated by using a super-resolution method based on the transfer function of each subband, separately. The resolution is a fraction of a chip duration, and the estimate is based on a sounding signal transmitted only in the disjoint frequency subbands.

Exploiting such a set of delay estimates, the method performs channel estimation over unmeasured subbands, and subsequently derives the frequency response over the entire wideband channel. Because there is no sounding signal transmitted over the unmeasured subbands, the channel estimation is said to be “blind.”

Finally, estimates derived from different subbands are combined via a soft combining technique. The super-resolution blind method can achieve a significant performance gain over conventional methods.

### BRIEF DESCRIPTION OF THE DRAWINGS

FIG. 1 is the block diagram of a super-resolution blind channel modeling system according to embodiments of the invention;

FIG. 2 is a schematic of a measurement channel for K=2;

FIG. 3 is the block diagram of a three-step super-resolution blind channel modeling method according to embodiments of the invention;

FIG. 4 is a graph of autocorrelation functions of raised cosine pulse-shaped PN sequence with different values of rolloff factor β according to embodiments of the invention;

FIG. 5 is a schematic of super-resolution delay estimation by exploiting y^{(k)}(t) according to embodiments of the invention; and

FIG. 6 is a graph of example weighting coefficients employed for soft combining according to embodiments of the invention;

### DETAILED DESCRIPTION OF THE PREFERRED EMBODIMENTS

The embodiments of our invention provide a method for estimating a frequency response of a wideband channel, and subsequently extracting a channel model when only measurements in parts of the wideband channel are available, specifically in disjoint frequency subbands.

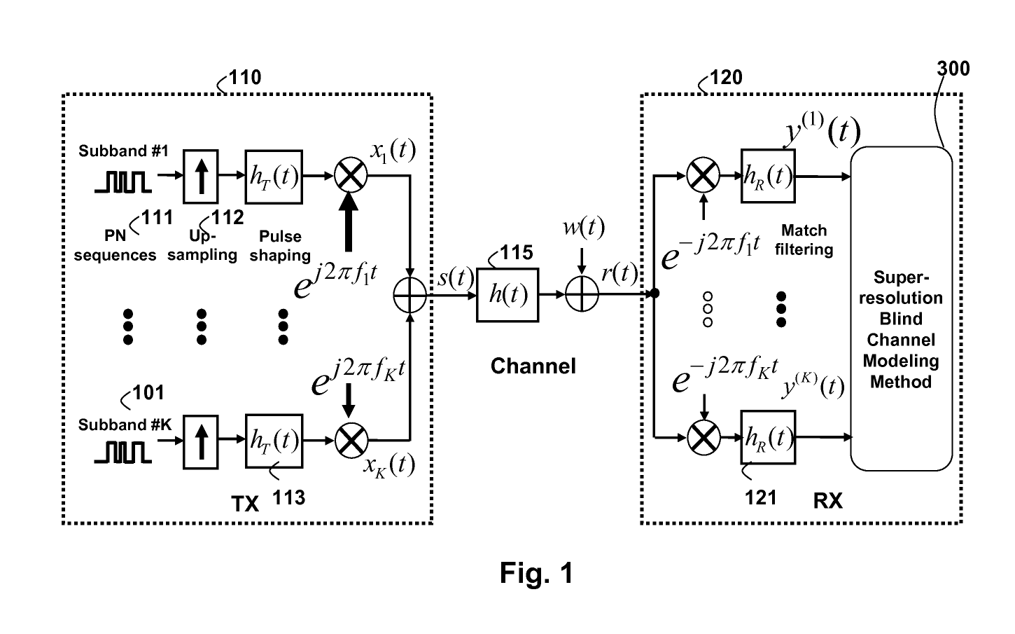

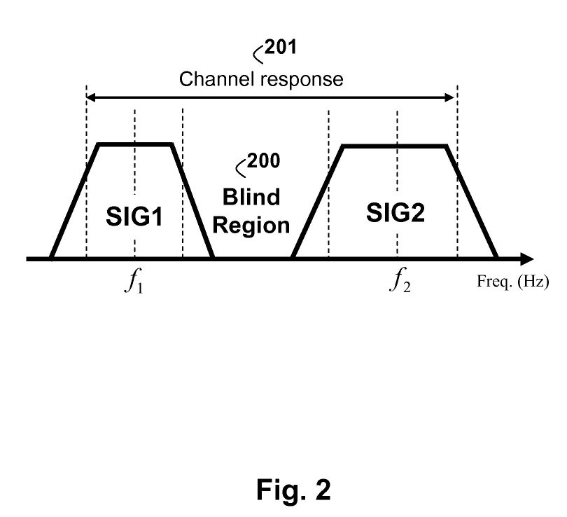

As show in FIG. 1, the system includes a transmitter TX) 110 and a receiver (RX) 120 connected by a wireless channel 115. The system uses of K disjoint narrowband subbands 101 separated by guard bands (also referred to as the blind regions). FIG. 2 illustrates a particular case with K=2 subbands. Note that the bandwidth of each subband, or guard band can differ.

As shown in FIG. 1, a sounding signal comprising of G repeated pseudo-noise (PN) sequences 111 is first up-sampled 112 before being fed into a pulse shaping filter h_{T}(t) 113, such as a square-root raised cosine filter. After that, the pulsed-shaped signal is up-converted to fₖ and transmitted through the k^{th} subband. As a result, the transmit signal s(t) is a superposition of multiple narrowband sounding signals transmitted over different disjoint narrow frequency subbands.

We consider a frequency-selective channel comprised of L discrete MPCs. Thus, the channel impulse response can be expressed as

$$h ( t ) = {\sum }_{l = 1}^{L} {α}_{l} \cdot δ ( t - {τ}_{l} ) , \qquad ( 1 )$$

where δ(•) is the delta function while αₗ and τₗ are the path gain and delay of the l^{th} MPC, respectively. Note, we have implicitly assumed that the channel remains approximately static over the G PN sequences.

The receiver includes matching filters 121 and the super-resolution lind channel modeling method 300, described in detail below, according to embodiments of the invention. The received signal can be written as the convolution of s(t) and h(t) and reads

r(t)=∫_{-∞}^{∞}h(τ)s(t−τ)dτ+w(t), (2)

where w(t) is modeled as zero-mean complex Gaussian noise, CN(0, σ²).

Upon receiving r(t), the receiver first down-converts the received signal in each subband to baseband and matched filters 121 the down-converted signals with h_{R} (t). The resulting k^{th} subband received signal after the matched filtering is y^{(k)}(t), for k=1, 2, . . . , K.

The transmitted signal after a delay τ is x(t−τ).

Denote by H(f) the frequency response of h(t). Clearly, a straightforward least-squares (LS) estimate of H(f) can be derived as follows.

$$\hat{H} ( f ) = \frac{R ( f )}{S ( f )} , \qquad ( 3 )$$

where R(f) and S(f) are the Fourier transforms of r(t) and s(t), respectively.

As shown in FIG. 2, the response 201 for the entire channel is estimated form sounding signals transmitted at frequency bands SIG1=f₁ and SIG2=f₂. Because S(f)≈0 is over the blind region 200, the estimate Ĥ(f) derived from Eqn. (3) incurs substantial estimation errors over the blind region. It is fair to mention that the conventional method can be slightly improved by linear (or other) interpolation-based techniques between the measured subchannels. However, the improvement is minor if the width of the blind region is larger than the coherence bandwidth of the channel. Hereinafter, the method shown in Eqn. (3) is referred to as the conventional method.

In the following, we describe a super-resolution blind method to derive the channel frequency response H(f) by exploiting sounding signals in disjoint subbands. For presentational clarity, we concentrate on the case of K=2, as shown in FIG. 1. However, it should be emphasized that the following discussion can be extended to K>2 in a straightforward manner.

Step 1: Super-Solution Delay Estimation

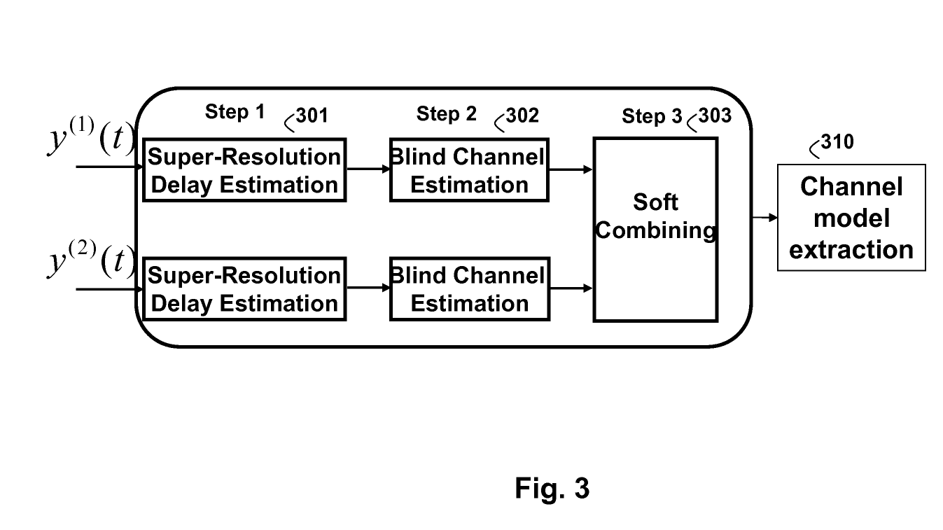

FIG. 3 shows our channel modeling method. In the first step 301, super-resolution delay estimation is performed by a modified delay-domain MUSIC, or frequency-domain ESPRIT method. Denote by T_{c} and U the PN sequence chip duration and the number of chips per PN sequence, respectively.

In contrast to the conventional PN correlation method in which the resolution of path delay estimation is limited by T_{c}, the present super-resolution delay estimation can provide estimates of resolution of a fraction of T_{c}. In particular, the ESPRIT method is more computationally advantageous than MUSIC because it does not require exhaustive search.

Our method improves on the ESPRIT method as follows. Two key differences distinguish the our method from ESPRIT: (1) we take pulse shaping into account; and (2) rather than directly applying ESPRIT to the received signal as proposed previously, we apply the ESPRIT method only after correlating the received signal with the transmitted PN sequence. Convnetinal MUSIC and ESPRIT are described in U.S. Pat. Nos. 7,609,786 and 4,750,147, incorporated herein by reference.

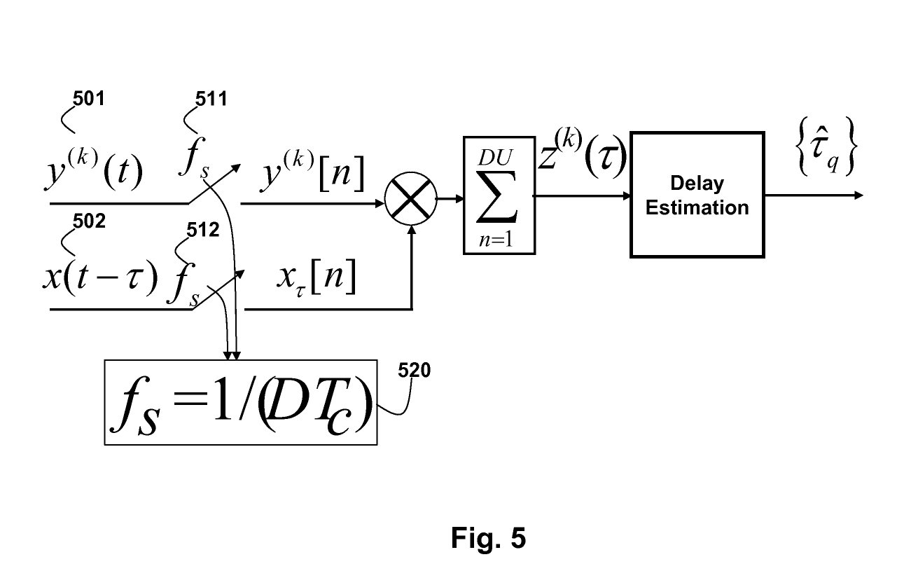

As shown in greater detail in FIG. 5, The received signal y^{(k)})(t) 501 for the k^{th} subband after matched filtering, and τ-delayed transmitted signal x(t) 502 are D-time oversampled 511-512, respectively, at a frequency fₛ=1(DT_{c}) 520. Then, y^{(k)}[n] is correlated with x_{τ}[n] and summed over one PN sequence of DU samples. The resulting z^{(k)})(τ) takes the following form

$${z}^{( k )} ( τ ) = {\sum }_{l = 1}^{L} {α}_{l} \cdot {e}^{- j2 {πτ}_{l} {f}_{k}} \cdot v ( τ ) + {ψ}^{( k )} ( τ ) , \qquad ( 4 )$$

where ν(τ) is the autocorrelation function of the pulse-shaped PN sequence and ψ^{(k)}(t) is the additive noise after correlation.

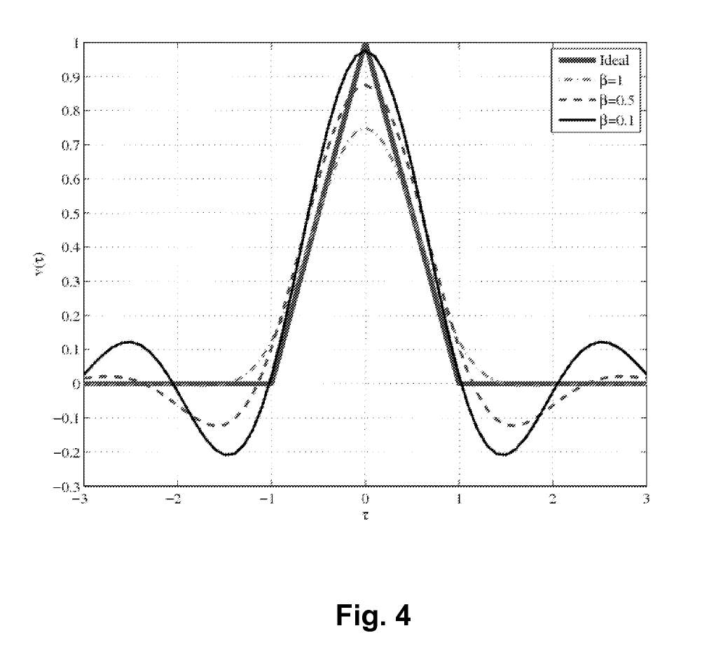

FIG. 4 shows the function ν(τ) of raised cosine pulse-shaped

PN sequences with different values of rolloff factors β (1, 0.5, and 0.1). It is interesting to observe from FIG. 4 that the autocorrelation function associated with a smaller rolloff β entails larger ripples outside [−1,+1] as compared to the ideal autocorrelation function. In other words, a smaller rolloff factor results in better band-limiting performance at the cost of more interference for super-resolution delay estimation.

Then, we can convert z^{(k)}(τ) into the frequency domain before performing the frequency based delay estimation as follows. After deconvolution, we have

$${J}^{( k )} ( f ) = \frac{{Z}^{( k )} ( f )}{V ( f )} = {\sum }_{l = 1}^{L} {α}_{l} \cdot {e}^{- j 2 π {τ}_{l} {f}_{k}} + {Ξ}^{( k )} ( f ) , \\ where \\ {Ξ}^{( k )} ( f ) = \frac{{Ψ}^{( k )} ( f )}{V ( f )} \\ with \\ {Z}^{( k )} ( f ) , V ( f ) \\ and \\ {Ψ}^{( k )} ( f ) \qquad ( 5 )$$

being the Fourier transforms of z^{(k)}(τ), ν(τ) and ψ^{(k)})(τ), respectively. N samples of J^{(k)}(f) are taken from its main lobe at f=0, Δ, 2Δ, . . . , (N−1)Δ. It can be shown that the noise correlation matrix is given by

$${[ {R}_{{Ξ}^{( k )}} ]}_{p , q} = \frac{{σ}^{2} \cdot {F}_{N} ( p , : ) \cdot {R}_{0} \cdot {F}_{N}^{H} ( q , : )}{{\vert V ( p Δ ) \vert}^{2}} , \qquad ( 6 )$$

where 0≦p,q≦N−1 and R₀ is the pulse-shaped noise covariance matrix with [R₀]_{p,q}=ν(τₚ−τ_{q}).

Substituting Eqn. (6) into the frequency-domain ESPRIT method, we can extract super-resolution estimates of path delays denoted by by {\hat{τ}_{q}^{(k)}}, where q=1, 2, . . . , Q with Q≧L.

### Step 2: Blind Channel Estimation

In the second step 302, after attaining {\hat{τ}_{q}^{(k)}}, two approaches can be utilized to derive the channel impulse response, namely delay-domain and frequency-domain approaches.

In the delay-domain approach, we first collect I samples before forming a vector z^{(k)}=[z^{(k)}(T₁) z^{(k)}(T₂) . . . z^{(k)}(T_{I})]^{T}.

From Eqn. (4), it is straightforward to show that z^{(k)} can be rewritten in the following matrix form:

z^{(k)}=B(τ)·α+Ψ^{(k)}, (7)

where

α=[α₁ α₂ . . . α_{L}]^{T},B(τ)=[v(τ₁) v(τ₂) . . . v(τ_{L})] and

v(τₗ)=[ν(T₁τₗ) ν(T₂τₗ) . . . ν(T_{I}−τₗ)]^{T}.

As a result, the LS estimate of a can be derived as

\hat{α}=[B(\hat{τ})]†z^{(k)}. (8)

However, one possible drawback associated with the delay-domain approach is that the channel frequency response derived from Eqn. (8) can exhibit large deviation from that estimated in Eqn. (3) over the k^{th} subband. Thus motivated, we next describe the frequency-domain approach that extracts the channel amplitudes by exploiting the estimates derived from Eqn. (3).

First, we define the channel impulse response vector as

h_{N}=[H₀,h₁, . . . h_{N-1}]^{T},

where only L elements are non-zero. In the following, we exploit the fact that

H(f)=F_{N}·h_{N}=F_{N}·T·h_{L′}, (9)

where h_{L′} contains only the L non-zero elements of h_{N} and T is an N×L matrix whose l^{th} column is the └fₛτₗ┘th column of I_{N}. Thus, F_{N}·T is a sub-matrix of F_{N} with only the corresponding columns. Because {τₗ} is not available, we replace {τₗ} with {\hat{τ}_{q}^{(k)}} and Eqn. (9) becomes

Ĥ^{(k)}(f)=F_{N}T^{(k)}·h_{Q′}^{(k)}+η (10)

where η is the additive noise and T^{(k)} is an N×Q matrix whose q^{th} column is the └fₛ\hat{τ}_{q}^{(k)}┘^{th} column of I_{N}. Thus, we have

ĥ_{Q′}^{(k)}=[F_{N}·T^{(k)}]†Ĥ^{(k)}(f). (11)

However, recall that estimates of Ĥ^{(k)}(f) derived from Eqn. (3) are reliable only over the k^{th} subband. Thus, in Eqn. (11), we take M^{(k)}>Q samples of Ĥ^{(k)}(f) only over the k^{th} subband derived from Eqn. (3). Finally, substitution of ĥ_{Q′}^{(k)} into Eqn. (10) results in the estimate of Ĥ^{(k)}(f) over the subband.

Step 3: Soft Combining

The third step 303 combines Ĥ^{(k)}, k=1,2, to provide an accurate channel estimate over the entire wideband channel. Clearly, the resulting estimate has to satisfy at least the following two requirements.

First, the combined estimate should render a continuous frequency response over the entire channel.

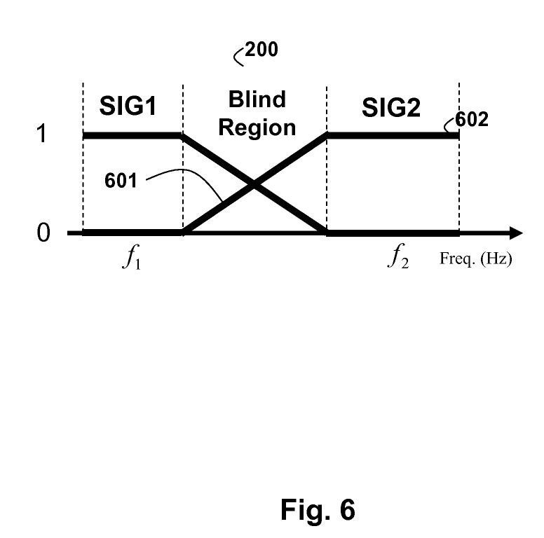

Second, the combined estimate should provide good estimates over the blind regions as well as the measurement subbands. A soft-combining approach can be established as follows:

$$\hat{H} ( f ) = {\sum }_{k = 1}^{K} {ρ}_{k} ( f ) \cdot {\hat{H}}^{( k )} ( f ) , \qquad ( 12 )$$

where ρₖ(f)≧0 are weighting coefficients at frequency f with Σρₖ²(f)=1, as shown in FIG. 6. That is, the soft combining is probabilistic.

It is easy to see that {ρₖ(f)} should be designed to accurately reflect the reliability of Ĥ^{(k)}(f). Note that Ĥ^{(k)}(f) becomes less reliable as f falls far from the k^{th} subband. Inspired by this observation, a simple but effective design example of {ρₖ(f)} is shown in FIG. 6 where ρₖ (f) remains unity over the k^{th} subband and linearly decreases to zero over the blind region.

### EFFECT OF THE INVENTION

The invention provides a method for reconstructing propagation channels from measurements in disjoint subbands of a frequency band of interest. By using high-resolution estimation of the multipath parameters, and suitable combining of the results, we have derived a model that accurately interpolates between the measured subbands.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for estimating a frequency response of an entire channel, wherein the channel is a wideband channel and only measurements in parts of the channel are available, wherein the parts are subbands, and wherein the subbands are disjoint and narrow frequency, comprising:
estimating delays in the subbands at a resolution that is a fraction of a chip duration based on a sounding signal transmitted only in the subbands;
determining channel impulse responses of the subbands based on the delays; and
combining probabilistically the channel impulse responses to extract a model of the entire channel.

2. The method of claim 1, wherein bandwidths of the subbands differ.

3. The method of claim 1, wherein the estimating further comprises:
oversampling a received signal y^{k}(t) for each k^{th} subband after match filtering;
oversampling a delayed transmitted signal x(t−τ) having a delay τ;
summing the correlated received signal and the delayed transmitted signal to produce a resulting signal z^{k}(t);
estimating the delay τ.

4. The method of claim 3, further comprising:
converting the resulting signal z^{(k)}(τ) into a frequency domain before performing the estimating.

5. The method of claim 1, wherein the estimating is performed in a delay-domain.

6. The method of claim 1, wherein the estimating is performed in a frequency-domain.

7. The method of claim 1, wherein the combining uses weighting coefficients.
